(19) United States
(12) Patent Application Publication
(10) Pub. No.: US 2014/0127423 A1
(43) Pub. Date: May 8, 2014

(54) METHOD FOR PREVENTING CORROSION BETWEEN TWO WORKPIECES

(71) Applicant: DANA AUTOMOTIVE SYSTEMS GROUP, LLC, Maumee, OH (US)

(72) Inventors: Stephen James-Essary Springer, Monroe, MI (US); Tom O'Neil, Holland, OH (US)

(73) Assignee: DANA AUTOMOTIVE SYSTEMS GROUP, LLC, Maumee, OH (US)

(21) Appl. No.: 14/072,940

(22) Filed: Nov. 6, 2013

Related U.S. Application Data
(60) Provisional application No. 61/723,444, filed on Nov. 7, 2012.

(51) Int. Cl. B29C 71/02

(52) U.S. Cl. CPC F16C 3/023
USPC 427/541

(57) ABSTRACT

A method for protecting joined workpieces from salt or other environmental hazards is described. The method may include joining an end fitting into a driveshaft tube which results in a gap between the two. The gap may be cleaned and dried before a moisture protecting urethane coating is applied. A urethane coating may be sprayed on as the joined end fitting and tube are rotated together. The coating penetrates into the gap and extends laterally beyond the gap and is subsequently cured with an ultraviolet light source.

### RELATED APPLICATIONS

This application is claiming the benefit, under 35 U.S.C. §119(e), of the provisional application filed on Nov. 7, 2012, under 35 U.S.C. §111(b), which was granted Ser. No. 61/723,444, and is hereby incorporated by reference in its entirety.

### FIELD OF THE INVENTION

The present invention relates to methods for preventing corrosion between two workpieces. More specifically, the invention relates to preventing corrosion between two workpieces made of different materials. The workpieces may be part of a driveshaft assembly.

### BACKGROUND OF THE INVENTION

The magnetic pulse welding technique is known and commonly used as a way to join two workpieces together. Driveshaft assemblies, comprising a driveshaft tube and an end fitting, can be formed using this technique. US RE 41,101 to Yablochnikov is one example providing background on the use of this technique to assemble driveshafts. US RE 41,101 is hereby incorporated herein to the extent permitted by law.

Briefly, a hollow driveshaft tube with an end opening, where the end opening is initially disposed coaxially around a neck portion of an endfitting, is provided. Before the magnetic pulse welding operation occurs, an annular gap exists between the driveshaft tube and the end fitting. Then, an electrical inductor is provided concentrically about or within the coaxially overlapping portions of the driveshaft tube and the end fitting. The inductor is energized to generate a magnetic field that either collapses the outer workpiece (in this case the driveshaft tube end) inwardly into engagement with the inner workpiece or expands the inner workpiece (in this case the neck of the end fitting) into engagement with the outer workpiece. In either event, the high velocity impact of the two workpieces, as well as the large pressure exerted thereon, cause them to become permanently joined together. When one of the adjacent surfaces is tapered, the energization of the inductor causes the two workpieces to collide into one another in an axially progressive manner from one end of the tapered surface to the other This slanting type of collision is one of the physical conditions that is usually necessary to achieve a strong, high-quality weld in the process of magnetic pulse welding.

A gap will remain at the interface between the end surface of the drive shaft tube and the shoulder on the end fitting after magnetic pulse welding. The gap may retain dirt, debris and/or moisture if it is not sealed. The moisture can be particularly problematic as it can begin to corrode one or both of the materials of the two workpieces. If the moisture is comprised of salt water, such as found on a salted roadway, for example, the salt water can function as an electrolyte between the materials of the two workpieces, especially if the materials of the two workpieces are dissimilar. An electrolytic solution can cause corrosion to begin and the corrosion will continue if left untreated. Corrosion at the gap initially results in a degraded appearance. If the corrosion is not dealt with, it can compromise the connection between the tube and the fitting, thus permitting moisture, dirt and debris into the gap. After prolonged exposure, the weld could become compromised.

In order to prevent moisture from entering or residing in the gap, a coating can be applied to the gap. The coating prevents moisture, dirt and debris from reaching the gap. As a result, the gap does not experience corrosion and it does not become degraded.

The prior art usually address this issue by painting a sealant over the joint area. For example U.S. Pat. No. 6,389,697 recognizes that the magnetic pulse welding process joins aluminum and steel materials and that the interface has to be protected from corrosion due to galvanic action. The patent indicates “[t]hese concerns are easily addressed using conventional painting or sealing techniques in the joint areas.” U.S. Pat. No. 6,908,024 and U.S. Patent Application Publication No. 2005/0035586 which both deal with magnetic pulse welding of dissimilar materials, indicate that a corrosion inhibitor can be added to welded surfaces. Lastly, U.S. Patent Publication No. 2012/0071250 discloses a spacer between an end fitting and a drive shaft. The publication indicates that a UV-cured urethane coating could be sprayed onto the spacer of the desired component of the driveshaft assembly and subsequently cured with UV light.

However, the most of the prior art deal with joints in vehicle frame members while the present invention is preferably suited for a joining subjected to twisting. Therefore, the coating used here must be ductile enough to locate into the gap and have enough adherence to withstand difficult road or cleaning conditions. In addition, the coating of the current invention is built up by applying the coating and almost simultaneously curing the coating so that another coating layer can be rapidly applied on top of the first.

The embodiments of the present invention elucidated below describe an inventive method for preventing corrosion between two workpieces, especially when those workpieces are formed from dissimilar materials, as with a drive shaft tube component and end fitting component of a driveshaft assembly. The method may include coating a gap formed during magnetic pulse welding and curing the coating so that another layer of the coating can be rapidly applied. The coating over the gap prevents corrosion due to galvanizing action between two dissimilar metals.

### SUMMARY OF THE INVENTION

The present invention is directed toward a method for treating joined workpieces. The method involves joining an end fitting into a driveshaft tube resulting in a gap between the two. The gap is cleaned and dried. As the joined end fitting and tube are rotated, a urethane coating is applied. Preferably, a dispensing head located adjacent to the rotating joined end fitting and tube is used to apply the coating. The coating penetrates into the gap and extends laterally beyond the gap. The coating is then cured with ultraviolet light.

In another embodiment, the method for treating joined workpieces, includes locating an end fitting into a driveshaft tube resulting in a circumferential interface between the end fitting and the tube. The interface may be subject to a torsional load. A first continuous layer of urethane coating is applied into and laterally beyond the interface to create a moisture seal about the interface. The first continuous layer is cured with an ultraviolet light source. Subsequently, at least a second continuous coating on top of the first coating is applied. The at least second continuous coating is then cured with an ultraviolet light source.

In accordance with the present invention, it has been discovered that by coating the gap at the weld interface of a driveshaft assembly in accordance with the preferred methods, the wed interface is better protected from exposure to the elements and is, therefore, better protected from corrosion. Likewise, a driveshaft assembly coated using the methods of the present invention shows improved protection against corrosion.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is an exploded perspective view of an end fitting and a driveshaft tube shown prior to being assembled and secured together by means of a magnetic pulse welding operation.

FIG. 2 is a further enlarged sectional elevational view showing portions of the end fitting and driveshaft tube prior to the commencement of the magnetic pulse welding operation.

FIG. 3 is an enlarged sectional elevational view showing portions of the end fitting and driveshaft tube after performance of the magnetic pulse welding operation.

FIG. 4 shows an assembly for providing a coating to a driveshaft assembly after performance of the magnetic pulse welding operation.

FIG. 5 is an enlarged sectional elevational view showing portions of the end fitting and driveshaft tube after performance of the magnetic pulse welding operation with the coating applied.

### DETAILED DESCRIPTION OF THE PREFERRED EMBODIMENTS

Described herein is a method for preventing corrosion between two workpieces. It has been found that when two workpieces are joined together using magnetic pulse welding, a gap may result at the welding interface. If through the gap the weld between the workpieces is exposed to certain environmental conditions, such as salt water, the salt water in the gap of the workpieces can cause them to undesirably corrode. A method and apparatus are needed to prevent the corrosion.

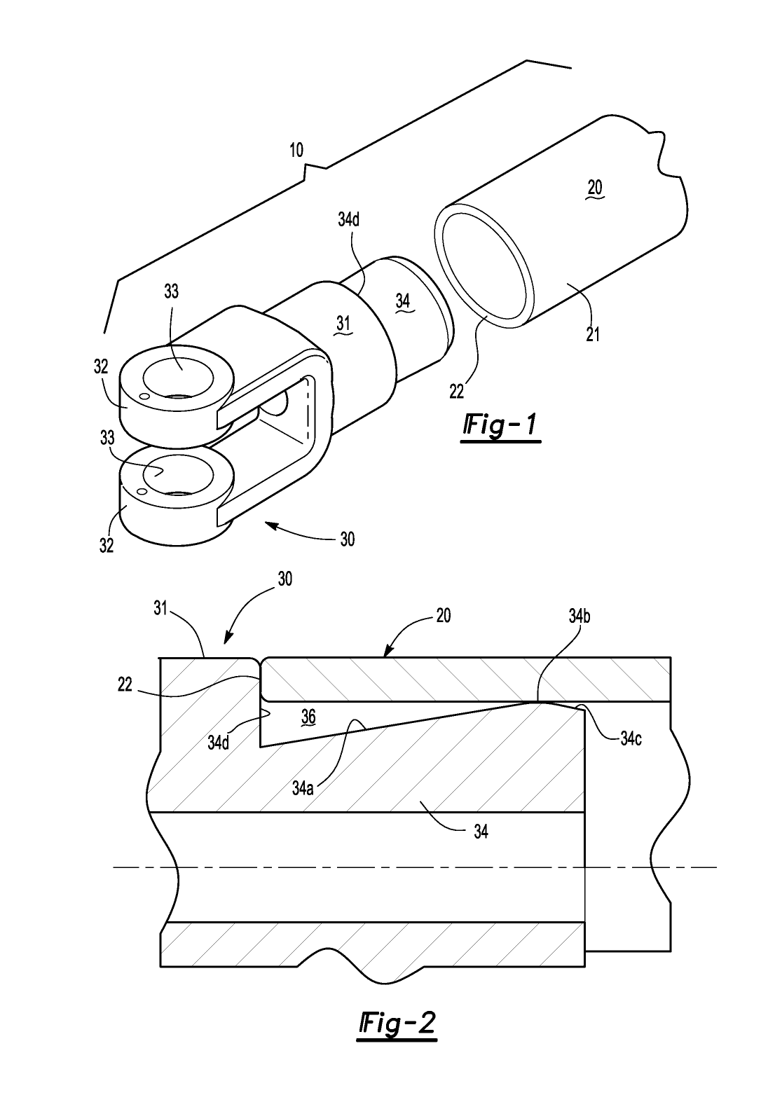

Many component workpieces, such as driveshaft assembly components, are usually made of metals or metal containing materials, although the material used for the workpieces should not be construed as being limited to metal or metal containing materials by this disclosure. Any suitable material, such as plastic as one non-limiting example, may be used. In driveshaft assemblies, such as the portion of the driveshaft assembly 10 shown in FIG. 1, the driveshaft tube 20 and end fitting 30 may be made from different metals or metal containing materials different than each other. For instance, one of the workpieces may be made from steel and the other from aluminum.

Sometimes it is this difference in materials used for the two workpieces that can cause corrosion due to galvanizing effects in the presence of environmentally available electrolytes. One example of this is with a driveshaft tube 20 and end fitting 30 made from different materials. When the driveshaft assembly is exposed to salt water, such as from salt mixed with precipitation on winter roads, corrosion can occur at joints between the two workpieces.

FIG. 1 shows an end fitting 30 and a driveshaft tube 20 shown prior to being assembled and secured together by means of a magnetic pulse welding operation. Although any end fitting can be used with the method of the present invention, FIG. 1 shows, by way of example only and not intending to be limiting, a yoke type end fitting 30.

Although this invention will be described and illustrated in the context of securing an end fitting 30 to a driveshaft tube 20 to form a portion of a driveshaft assembly 10, it will be appreciated that the apparatus and method of this invention can be used with any two or more workpieces that are joined together for any desired purpose or application. It will also be appreciated that the invention can be used simply to fill a gap or void in any structure, whether that gap or void is created at the interface of two or more structures or if the gap or void is located anywhere within a unitary structure.

The illustrated driveshaft tube 20 is generally hollow and cylindrical in shape and can be formed from any desired material, such as 6061 T6 aluminum alloy, for example. Preferably, the driveshaft tube 20 is substantially cylindrical with uniform wall thickness, although such is not required. The driveshaft tube 20 has an end portion 21 that terminates at an end surface 22.

The illustrated end fitting 30 is a tube yoke formed from a material that can be either the same as or different from the material used to form the driveshaft tube 20, such as steel or an alloy of aluminum, for example. The end fitting 30 as shown in FIG. 1 may have a body portion 31 having a pair of opposed yoke arms 32 that extend therefrom in a first axial direction. A pair of aligned openings 33 are formed through the yoke arms 32 and are adapted to receive conventional bearing cups (not shown) of a universal joint cross therein. A generally hollow neck portion 34 extends axially in a second axial direction from the body portion 31.

FIG. 2 illustrates the structure of the neck portion 34 of the end fitting 30 in more detail, albeit in a somewhat exaggerated manner. As shown therein, the neck portion 34 of the end fitting 30 preferably has an outer surface including a first tapered portion 34a that tapers outwardly from a relatively small outer diameter adjacent to the body portion 31 to an outermost point 34b. The outer surface of the neck portion 34 further include a second tapered portion 34c that tapers inwardly from the outermost point 34b to the axial end of the neck portion 34. The outer surface of the neck portion 34 is preferably smaller in diameter than the outer diameter of the body portion 31. As a result, an annular shoulder 34d is defined between the neck portion 34 and the body portion 31 of the end fitting 30.

The outermost point 34b of the neck portion 34 can, if desired, define an outer diameter that is either approximately equal to or slightly smaller in diameter than the inner diameter defined by the inner surface of the end portion 21 of the driveshaft tube 20. Thus, when the end portion 21 of the driveshaft tube 20 is disposed about the neck portion 34 of the end fitting 30 as shown in FIG. 2, the two components are positively located relative to one another. However, the outer diameter defined by the outermost point 34b of the neck portion 34 can, if desired, be somewhat smaller in diameter than the inner diameter defined by the inner surface of the end portion 21 of the driveshaft tube 20. The outer diameter can also be larger in diameter than the inner diameter so as to create an interference fit.

The second tapered portion 34c of the outer surface of the neck portion 34 is provided to facilitate the axial installation of the end portion 21 of the driveshaft tube 20 onto the neck portion 34 of the end fitting 30 in a known manner. The hollow neck portion 34 of the end fitting 30 may have a substantially uniform wall thickness, although such is not required. This tapered outer surface of the neck portion 34a of the end fitting 30 has been found to provide good results during the performance of a magnetic welding process that is discussed in detail below. A more detailed explanation of the structure of the neck portion 34 of the end fitting 30 can be found in U.S. Pat. No. 5,981,921. The disclosure of that patent is incorporated herein by reference to the extent permitted by law.

While the above references one end fitting design, other end fitting designs are permissible. The present invention works equally well where any two components are put together and a gap results.

Typically, the end portion 21 of the driveshaft tube 20 is installed onto the neck portion 34 of the end fitting 30 by moving it axially thereover until the end surface 22 of the driveshaft tube 20 abuts the shoulder 34d on the end fitting 30 as shown in FIG. 2, although such is not required. When the driveshaft tube 20 and the end fitting 30 are assembled in this manner, an annular gap or space 36 (see FIG. 2) is defined between the inner surface of the end portion 21 of the driveshaft tube 20 and outer surface of the neck portion 34 of the end fitting 30. The size of the gap 36 can vary in radial dimension with the tapered shape of the outer surface of the neck portion 34 of the end fitting 30, although such is not required. Typically, the radial dimension of such gap 36 will be up to a maximum of about five millimeters, although the gap 36 may have any desired dimension. Preferably, the gap 36 is substantially uniform circumferentially about the axially overlapping portions of the end portion 21 of the driveshaft tube 20 and the neck portion 34 of the end fitting 30, although such is not required.

The end fitting 30 and tube 20 are located within a magnetic pulse welding machine. The machine and magnetic pulse welding (MPW) process may be as described in RE41,101, U.S. Pat. Nos. 4,129,846 and 5,981,921 which are hereby incorporated by reference herein to the extent permitted by law.

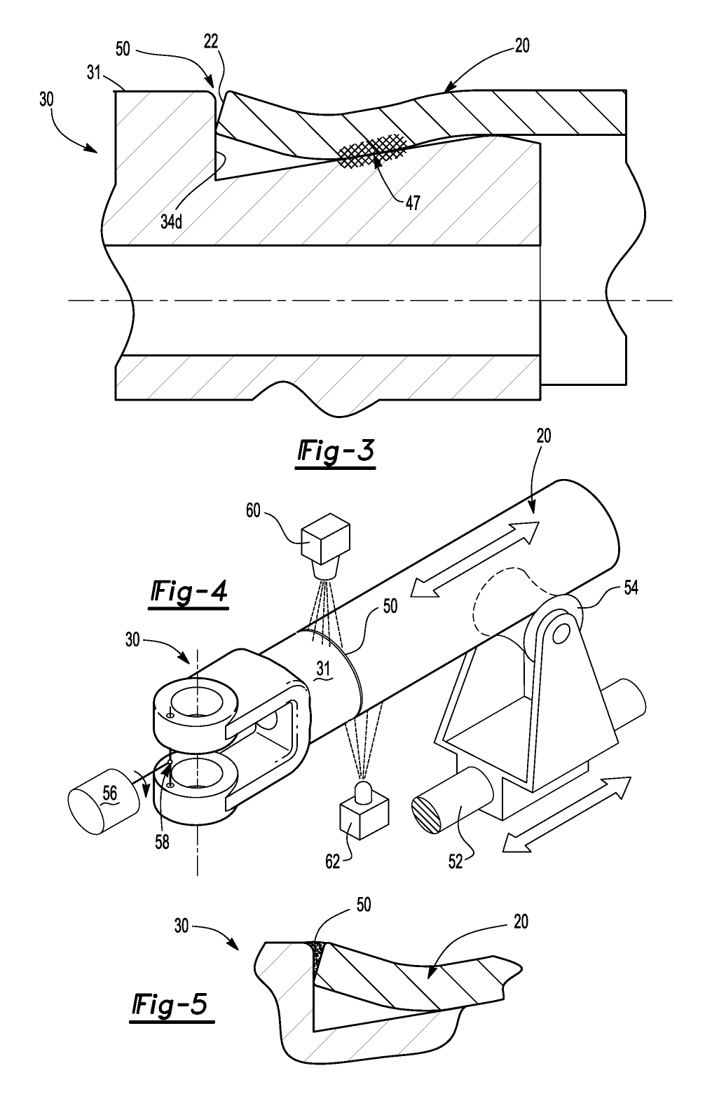

The MPW process generates an immense and momentary electromagnetic field about the end portion 21 of the driveshaft tube 20. The electromagnetic field exerts a very large force on the outer surface of the end portion 21 of the driveshaft tube 20, causing it to collapse inwardly at a high velocity onto the neck portion 34 of the end fitting 30, as shown in FIG. 3. The resulting impact of the inner surface of the end portion 21 of the driveshaft tube 20 with the outer surface of the neck portion 34 of the end fitting 30 causes a weld or molecular bond to occur therebetween, such as shown at the region 47 in FIG. 3.

The size and location of the weld region 47 will vary with a variety of factors, such as the size of the gap 36, the size, shape, and nature of the materials used to form the driveshaft tube 20 and the end fitting 30, the size and shape of the inductor used in the magnetic pulse welding operation, the angle and velocity of the impact between the end portion 21 of the driveshaft tube 20 and the neck portion 34 of the end fitting 30, and the like. It will be appreciated that the illustrated weld region 47 is intended to be representative of an exemplary prime welding area that provides the best possible adherence of the driveshaft tube 20 to the end fitting 30, and that other areas of the driveshaft tube 20 and the end fitting 30 may also be welded together as well during this process.

In some cases, after the magnetic pulse welding process, a gap 50 remains at the interface between the end surface 22 of the drive shaft tube 20 and the shoulder 34d on the end fitting 30. The gap may, or may not, be airtight and/or watertight, but is typically large enough to retain dirt, debris and/or moisture.

The moisture can be particularly problematic as it can begin to corrode one or both of the materials used in the construction of the driveshaft tube 20 and end fitting 30. For example, if the moisture is comprised of salt water, the salt water can function as an electrolyte between dissimilar metals, is the workpieces are comprised of metals. An electrolytic solution can cause corrosion to begin and it will continue if left untreated. Corrosion at the gap 50 initially results in a degraded appearance. If the corrosion is not dealt with, it can compromise the connection between the tube 20 and the fitting 21, thus permitting moisture, dirt and debris into the gap 50. After prolonged exposure, the weld 47 could become compromised.

In order to prevent moisture from entering or residing in the gap 50, a coating can be applied to the gap 50. The process of applying the coating may begin with a cleaning step. The cleaning step may comprise removing any surface dirt, debris, contaminants, or liquids from the gap 50 or surrounding area. Many different cleaning steps might be used depending on the type of material that may be present on or in the gap 50 and the degree to which the material is located on or in the gap 50.

Preferably, the coating is applied to a new end fitting 30 and a new tube 20 that have been joined after the magnetic pulse welding process. Thus, the tube 20 and end fitting 30 are typically relatively clean. In some instances isopropyl alcohol may be used as necessary as a solvent and/or cleaner to remove any debris from the end fitting 30, the tube 20 and/or the gap 50. Other solvents/cleaners may additionally or alternatively be used without going beyond the bounds of the invention described herein.

The cleaner/solvent may be applied by hand using a wipe, such as a towel, with the cleaner/solvent located automatically or manually thereon. The wipe can then be located in contact in and about the gap 50 so that it is clean. It is also permissible for the cleaning step to be automated in whole or in part. For example, a pad can be automatically loaded with cleaner/solvent and then automatically applied to the gap 50. The loading step can be automated via a computer and the application step can also be automated by a computer to apply the same amount of cleaner/solvent to the desired area for a predetermined time, pressure, etc.

A blowing/drying step may be used to further clean the gap 50 and/or to dry any cleaner/solvent or other liquids that remains on or in the gap 50. One example of how the blowing step can be achieved is shown in FIG. 4. In one embodiment, one or more dispensing heads 60 may direct pressurized air at the gap 50. The dispensing heads 60 may be stationary and the gap 50 may be rotated by them or the gap 50 may be stationary and the dispensing heads 60 move about it. Alternatively, there may be a plurality dispensing heads 60 positioned about the gap 50 so as to provide pressurized air entirely about the gap 50.

If the tube 20 is to be rotated, the tube 20 and its attached end fitting 30 can be located on a surface capable of supporting the tube 20 yet permitting it to rotate on the surface. One example of such as surface comprises a cradle 52 fitted with rollers 54 designed to contact and rotationally support the tube 20. One example of a cradle 52 is depicted in FIG. 4.

The end fitting 30 is connected to a source of rotation, such as an electric motor 56. The end fitting 30 may be connected to the motor 56, such as through the use of removable mechanical fasteners 58. The motor 56 and fasteners 58 are depicted in FIG. 4.

In an alternative embodiment, the dispensing head 60 can be used to dispense a coating. The coating may be any material that can be deposited in and about the gap 50. Preferably, the coating is in liquid form so that it can be sprayed on using the dispensing head 60, but other forms would be permissible. One example of a coating that may be used is urethane. Another example of a coating is a room temperature vulcanizing material (RTV), as either an acrylic or a silicon.

Regardless of the coating material used, it may be preferable to use a material that dries quickly, that does not detract from the appearance of the gap 50, that permits observation of the gap 50 after application and/or that can survive the extreme conditions that vehicle drive shafts are exposed to in the environment and elements.

Preferably, a ultraviolet cured urethane material is used, such as DYMAX 3025 available from Dymax Corporation of Torrington, Conn. The ultraviolet cured urethane has been found to meet all of the criteria listed above. The coating can be applied manually and/or automatically. If done manually, the steps described above for the cleaning step can be repeated for the coating step with the coating replacing the cleaner/solvent.

The coating may be applied to the gap 50 by the automated dispensing head 60. The tube 20 is rotated relative to the head 60 and the coating is applied at a predetermined amount for a predetermined time. In one embodiment, the tube 20 is rotated past the dispensing head 60 for 6 full revolutions of the shaft while the head 60 is dispensing the coating. The coating is uniformly applied entirely about the circumference of the gap 50 so that it completely fills the gap 50. Additionally, sufficient coating is applied so that it extends outwardly approximately 3 mm to approximately 8 mm from the center of the gap 50.

It has been found that an atomization pressure of approximately 12 psi is sufficient to distribute the coating in the embodiment described above. While this pressure setting is mentioned as being sufficient in practice, it can be appreciated that others may be used as well and different pressures may be necessary depending on the dispenser used or the viscosity of the coating to be used, or other similar factors.

Simultaneously, a source 62 of ultraviolet light can be provided adjacent the gap 50, as shown in FIG. 4. When turned on and located adjacent the gap 50, the ultraviolet light will quicken the curing step for the urethane coating. By simultaneously applying the coating and curing the coating with the ultraviolet light as the welded driveshaft assembly 10 is rotated, it is possible to build up the thickness by applying layer upon layer.

It may be preferable to have the ultraviolet light warm up for a predetermined amount of time before it is needed. Warm up times may be on the order of 15 minutes so that the light reaches full intensity. Preferably, the light produces intensity on the order of 100 mW/cm2.

After the tube 20 has completed the desired number of rotations during the coating application step, the tube 20 may be permitted to make additional revolutions to continue to expose the coating to the ultraviolet light for curing purposes. At the end of the curing step, the ultraviolet light may be removed from adjacent the interface or covered/blocked.

The resulting coating is preferably clear, smooth and glossy and free of visible contaminants and defects including porosity, craters, bubbles, blisters, tears and peeling. If desired, additional coatings can be applied over the initial coating, or at different locations along the shaft using the same process as described above.

The coating prevents moisture, dirt and debris from reaching the gap 50. As a result, the gap 50 does not experience corrosion and the weld 47 does not become degraded. FIG. 5 shows the driveshaft tube 20 and end fitting 30 after being welded and after the coating has been applied to the gap 50.

It should also be noted that the methods described herein will also aid in limiting production costs for the driveshaft assemblies. If the coating can be applied and cured almost simultaneously while the assembly is being rotated in front of the dispensing heads and ultraviolet light, there is less time spent waiting for traditional coatings to dry. Additionally, the methods described herein lend themselves to being automated, which will also cut costs.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed:

1. A method for treating joined workpieces, comprising the steps of:
joining an end fitting into a driveshaft tube resulting in a gap between said end fitting and said tube;
cleaning said gap of said joined end fitting and said driveshaft tube;
drying said gap of said joined end fitting and said driveshaft tube;
rotating said joined end fitting and tube together;
applying a urethane coating to said gap with a dispensing head located adjacent said rotating joined end fitting and tube, said coating penetrating into said gap and extending laterally beyond said gap; and
curing said coating with an ultraviolet light source.

2. The method of claim 1, further comprising the step of applying a second urethane coating to said gap following curing of a previous applied coating with an ultraviolet light source.

3. The method of claim 2, wherein the joined end fitting and tube are continuously rotated together while the urethane coating is both (1) applied to said gap and (2) subsequently cured.

4. The method of claim 3, wherein the joined end fitting and tube are rotated together for at least six complete rotations.

5. The method of claim 1, wherein the coating extends beyond the gap outwardly approximately 3 mm to approximately 8 mm from a center of the gap.

6. The method of claim 1, wherein the end fitting and the tube being joined are constructed of different materials.

7. A method for treating joined workpieces, comprising the steps of:
locating an end fitting into a driveshaft tube resulting in a circumferential interface between said end fitting and said tube, said interface subject is to a torsional load;
applying a first continuous urethane coating into and laterally beyond said interface to create a moisture seal about said interface;
curing said first continuous urethane coating with an ultraviolet light source;
applying at least a second continuous coating on top of said first coating; and curing said second coating.

8. The method of claim 7, wherein the circumferential interface is continuously rotated while the urethane coating is both (1) applied to said interface and (2) subsequently cured.

9. The method of claim 8, wherein the circumferential interface is rotated for at least six complete rotations.

10. The method of claim 7, wherein the coating extends beyond the interface outwardly approximately 3 mm to approximately 8 mm from a center of the interface.

11. The method of claim 7, wherein the end fitting and the tube are constructed of different materials.

12. A driveshaft assembly with a urethane coating applied over a gap, wherein the gap is formed at a welding interface after magnetic pulse welding.

13. A coated driveshaft assembly produced by the method of claim 1.

14. A coated driveshaft assembly produced by the method of claim 7.
